(19) United States
(12) Patent Application Publication
(10) Pub. No.: US 2005/0057924 A1
(43) Pub. Date: Mar. 17, 2005

(54) Embossed oil lamp and method of manufacture

(76) Inventor: Raymond B. Featherman III, Gladwyne, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/852,362

(22) Filed: May 24, 2004

Related U.S. Application Data
(60) Provisional application No. 60/472,838, filed on May 23, 2003.

(51) Int. Cl. B32B 5/02

(52) U.S. Cl. 362/159

(57) ABSTRACT

An oil lamp with simulated embossing including a lamp oil cartridge enclosing oil. The lamp oil cartridge has a base with a perimeter sidewall. The perimeter sidewall extends generally outwardly from the base then forms a neck. A wick extends through the neck and is configured to contact with oil in the cartridge. A wrapped material is positioned above the lamp oil cartridge with at least one raised portion thereon. The wrapped material blends with the lamp oil cartridge to create an embossed appearance for the oil lamp. The wrap material may be any one of heat shrunk, water shrunk, or closely wrapped over the lamp oil cartridge.

### CROSS REFERENCE TO RELATED APPLICATION

This application claims priority to and benefit of U.S. provisional patent application 60/472,838, filed May 23, 2003, entitled “Lamp With Embossed Wrap”, which is hereby incorporated by reference herein as if fully set forth in its entirety.

### BACKGROUND

The present invention is directed an embossed oil lamp and a method of manufacturing same.

Small disposable oil lamps have conventionally been used as outdoor lighting sources for businesses, but have failed to appeal to customers due to their cheap look or prohibitive cost of manufacturing an appealing disposable oil lamp. Overcoming the generally utilitarian look of conventional disposable oil lamps is especially difficult due to the limited amount that consumers have been willing to spend for such items. Using complicated manufacturing processes to make solid glass disposable oil lamps has resulted in the lamps having increased consumer appeal, but being relatively too expensive to produce.

One difficulty in making small outdoor disposable oil lamps for use at home has been the difficulty in creating an aesthetic look without eliminating the thin polymer casings normally used as the housing for oil cartridges in disposable lamps. The relatively thin casing limits the amount of material that can be processed during manufacturing and should continue to be used based on its resistance to fracture upon impact. Polymer housing also provide a cost efficient material for producing oil cartridges.

It would be advantageous to provide an oil lamp having an attractive esthetic look and method of making the same that could be used for small oil lamps; that can be used indoors or outdoors; and that can be used with oil lamps having a thin polymer housing or the like.

### SUMMARY

Briefly stated, one embodiment of the present invention is directed to a method of making an embossed oil lamp. The method includes the steps of: providing a lamp oil cartridge for holding oil, the lamp oil cartridge having a base with a perimeter side wall extending generally perpendicular therefrom, the perimeter sidewall extending through an approximately ninety (90°) degree bend to extend radially inwardly prior to bending to form a neck, on an end of the lamp cartridge generally opposite from the base, through which a wick extends; providing a heat shrinkable material with at least one raised portion thereon, the heat shrinkable material having a same color as the lamp oil cartridge; wrapping the heat shrinkable material around the sidewall of the lamp oil cartridge; heat shrinking the heat shrinkable material onto the lamp oil cartridge such that the at least one raised portion of the heat shrinkable material creates an embossed appearance for the lamp oil cartridge, the heat shrinkable material overlapping an entire edge of the lamp oil cartridge between the base and the sidewall to present a generally seamless look around a bottom portion of the lamp oil cartridge, the heat shrinkable material overlaps at least a portion of the neck to present a generally seamless look around an upper portion of the lamp oil cartridge; and providing a shield positioned over the lamp oil cartridge, the shield having a generally straight perimeter sidewall.

In a separate embodiment, the present invention is directed to a method of making an embossed oil lamp. The method includes the steps of: providing a lamp oil cartridge for holding oil, the lamp oil cartridge having a base with a perimeter sidewall extending generally perpendicularly therefrom, the perimeter sidewall forms a neck, on an end of the lamp oil cartridge generally opposite from the base, through which a wick extends; providing a heat shrinkable material with at least one raised portion thereon; wrapping the heat shrinkable material around the sidewall of the lamp oil cartridge; and heat shrinking the heat shrinkable material onto the lamp oil cartridge such that the at least one raised portion of the heat shrinkable material creates an embossed appearance for the lamp oil cartridge.

In a separate embodiment, the present invention is directed an oil lamp with simulated embossing including a lamp oil cartridge enclosing oil. The lamp oil cartridge has a base with a perimeter sidewall. The perimeter sidewall extends generally perpendicularly outwardly from the base, then extends through an approximately ninety (90°) degree bend to extend radially inwardly, and then bends generally away from the base to form a neck. The neck of the lamp oil cartridge is generally opposite from the base. A wick extends through the neck and is in contact with the oil. A wrapped material is positioned above the lamp oil cartridge with at least one raised portion thereon. The wrapped material is transparent to blend with the lamp oil cartridge to create an embossed, glass-like appearance for the lamp oil cartridge.

### BRIEF DESCRIPTION OF THE DRAWINGS

The foregoing summary, as well as the following detailed description of the preferred embodiment of the present invention will be better understood when read in conjunction with the appended drawings. For the purpose of illustrating the invention, there is shown in the drawings an embodiment which is presently preferred. It is understood, however, that the invention is not limited to the precise arrangement and instrumentality shown. In the drawings:

FIG. 1 is a front elevational view of a preferred embodiment of an embossed oil lamp of the present invention; and

FIG. 2 is a front elevational view of the embossed oil lamp of FIG. 1 with a shield placed thereover.

### DETAILED DESCRIPTION OF THE PREFERRED EMBODIMENT(S)

Certain terminology is used in the following description for convenience only and is not limiting. The words, “right,” “left,” “top,” and “bottom” designate directions in the drawings to which reference is made. The words “inwardly” and “outwardly” refer to directions toward and away from, respectively, the geometric center of the oil lamp and designated parts thereof. The words “a” and “one” are defined as including one or more of the referenced item unless specifically stated otherwise. This terminology includes the words above specifically mentioned, derivatives thereof, and words of similar import.

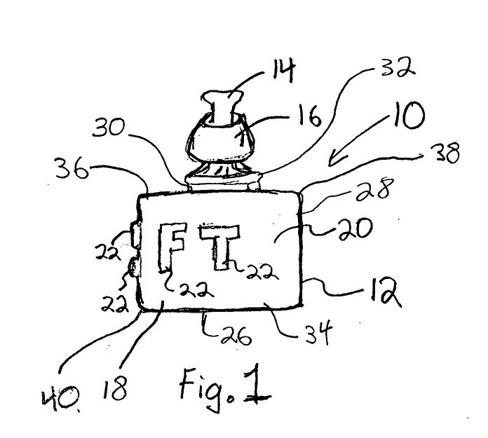

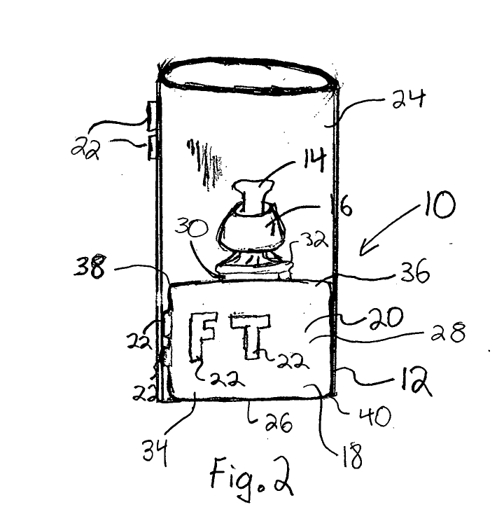

Referring to FIGS. 1 and 2, wherein like numerals indicate like elements throughout, a preferred embodiment of oil lamp is shown and generally designated as 10. The oil lamp presents an elegant embossed appearance while being relatively cost efficient to manufacture using relatively inexpensive machinery. Additionally, oil lamp 10 eliminates the need to pay for expensive embossed oil cartridges due to the method of the present invention allowing for embossing to be placed over the oil cartridge 12 either before or after the oil cartridge is filled with oil. One advantage of being able to emboss the cartridges after they are already filled with oil is increased flexibility in filling orders. Oil lamps 10 can be ready for shipping with the only step remaining to attach wrap material/heat shrink material 18 or the like prior to shipping.

It is preferred that the lamp oil cartridge 12 be manufactured of a flexible, non-reactive material such as a suitable polymer. However, those of ordinary skill in the art will appreciate that any suitable material can be used to form the lamp oil cartridge 12. It is also preferred that the cartridge cap 32 and the flame shield 16 be formed of a generally high temperature resistant material such as aluminum, steel, or the like.

One preferred method for making the embossed oil lamp will be detailed below. Those of ordinary skill in the art will appreciate that the various steps of the method of the present invention can be interchanged or performed in any order without departing from the scope of the present invention.

The method of the present invention includes providing a lamp oil cartridge 12 for holding oil. The lamp oil cartridge 12 preferably has a base 26 with a perimeter sidewall 28 extending generally perpendicularly therefrom. It is preferred that the perimeter sidewall 28 extend away from the base 26 by a predetermined distance that generally defines the height of the lamp oil cartridge 12, then extend through an approximately ninety (90°) degree bend 38 to extend generally radially inwardly prior to bending upwardly generally away from the base to form a neck 30. The neck 30 is formed on an end of the lamp oil cartridge 12 generally opposite from the base 26. The cartridge cap 32 is preferably secured over the neck. It is preferred that a wick extend through the neck.

While it is preferred the lamp oil cartridge 12 have a generally circular cross-section, those of ordinary skill in the art will appreciate that the cross-section of the lamp oil cartridge 12 can be rectilinear, polygonal, irregularly shaped, or the like without departing from the scope of the present invention. Similarly, while it is preferred that the perimeter sidewall 28 is generally straight and perpendicular to the base, it will be appreciated that the sidewall 28 can be curvilinear without departing from the present invention.

The method of the present invention includes providing a shrinkable material 18 with at least one raised portion 22 thereon. The shrinkable material is preferably heat shrinkable, but can also be water shrinkable without departing from the scope of the present invention. Alternatively, the wrap material 18 can be essentially extruded over the lamp oil cartridge 12 without any shrinking of the material being necessary to form the oil lamp 10 of the present invention. The raised portion 22 forms the embossed look on the lamp oil cartridge 12 when the oil lamp 10 is assembled. The heat shrinkable material preferably has a sand color as the lamp oil cartridge. For example, it is preferred that the heat shrinkable material 18 be generally transparent or translucent when the lamp oil cartridge is also generally transparent or translucent. This allows the oil in the oil lamp to provide a pleasing color to the oil lamp 10. Regardless of whether the heat shrinkable material 18 has the same color as the lamp oil cartridge 12, the heat shrinkable material 18 can be transparent to blend with the lamp oil cartridge 12 to create an embossed, glass-like appearance for the lamp oil cartridge 12.

The method of the present invention preferably includes wrapping the heat shrinkable material around the sidewall of the lamp oil cartridge and heat shrinking the heat shrinkable material 18 onto the lamp oil cartridge 12 such that the at least one raised portion 22 of the heat shrinkable material 18 creates an embossed appearance for the lamp oil cartridge 12. The raised portion 22 can form embossing for words, pictures, or any decorative design without departing from the scope of the present invention.

It is preferred that the heat shrinkable material 18 generally overlap an entire edge 42 of the lamp oil cartridge 12 between the base 26 and sidewall 28 to present a generally seamless look around a bottom portion 34 of the lamp oil cartridge 12. The heat shrinkable material 18 preferably generally overlaps at least a portion of the neck 30 to present a generally seamless look around an upper portion 36 of the lamp oil cartridge 12.

The method of the present invention preferably includes providing a shield 24 that is positionable over the lamp oil cartridge 12. The shield 24 is preferably generally cylindrical in cross section and has generally straight perimeter sidewalls 28. The shield is preferably embossed with raised portions 22 to compliment the embossed appearance of the lamp oil cartridge 12. Those of ordinary skill in the art will appreciate that the cross sectional shape of the shield can vary without departing from the scope of the present invention.

By using complementary embossing on both the shield 24 and the lamp oil cartridge 12, an enhanced esthetic effect can be created. For example, clouds can be depicted on an upper portion of the shield 24 while a landscape scene can be shown on the lamp oil cartridge 12. By coordinating the images and coloring of the embossed portions of the shield 24 and lamp oil cartridge 12, a more appealing outdoor lamp can be provided. Another advantage to the method of the present invention is that the wrap material can be sold as a kit to allow consumers to retrofit oil lamps 10 as desired.

It will be recognized by those skilled in the art that changes may be made to the above describe embodiment of the invention without departing from the broad inventive concept thereof. It is understood, therefore, that this invention is not limited to the particular embodiments disclosed, but is intended to cover all of the modifications which are within the spirit and scope of the invention as defined by the appended claims and/or shown in the attached drawings.

1. A method of making an embossed oil lamp, comprising the steps of:
providing a lamp oil cartridge for holding oil, the lamp oil cartridge having a base with a perimeter sidewall extending generally perpendicularly therefrom, the perimeter sidewall extending through an approximately ninety degree bend to extend radially inwardly prior to bending to form a neck, on an end of the lamp oil cartridge generally opposite from the base, through which a wick extends;
providing a heat shrinkable material with at least one raised portion thereon, the heat shrinkable material having a same color as the lamp oil cartridge;
wrapping the heat shrinkable material around the sidewall of the lamp oil cartridge;
heat shrinking the heat shrinkable material onto the lamp oil cartridge such that the at least one raised portion of the heat shrinkable material creates an embossed appearance for the lamp oil cartridge, the heat shrinkable material overlapping an entire edge of the lamp oil cartridge between the base and the sidewall to present a generally seamless look around a bottom portion of the lamp oil cartridge, the heat shrinkable material overlaps at least a portion of the neck to present a generally seamless look around an upper portion of the of the lamp oil cartridge; and
providing a shield positioned over the lamp oil cartridge, the shield having a generally straight perimeter sidewall.

2. A method of making an embossed oil lamp, comprising the steps of:
providing a lamp oil cartridge for holding oil, the lamp oil cartridge having a base with a perimeter sidewall extending generally perpendicularly therefrom, the perimeter sidewall forming a neck, on an end of the lamp oil cartridge generally opposite from the base, through which a wick extends;
providing a heat shrinkable material with at least one raised portion thereon;
wrapping the heat shrinkable material around the sidewall of the lamp oil cartridge; and
heat shrinking the heat shrinkable material onto the lamp oil cartridge such that the at least one raised portion of the heat shrinkable material creates an embossed appearance for the lamp oil cartridge.

3. The method of claim 2, further comprising selecting a material for the heat shrinkable material that has a color which matches a color of the lamp oil cartridge.

4. The method of claim 3, wherein the step of heat shrinking includes heat shrinking the heat shrinkable material so that the heat shrinkable material overlaps an entire edge of the lamp oil cartridge between the base and the sidewall to present a generally seamless look around a bottom portion of the lamp oil cartridge.

5. The method of claim 4, wherein the step of heat shrinking includes heat shrinking the heat shrinkable material so that the heat shrinkable material overlaps at least a portion of the neck to present a generally seamless look around an upper portion of the lamp oil cartridge.

6. The method of claim 5, further comprising providing a shield positioned over the lamp oil cartridge, the shield being generally cylindrical in cross section and having a generally straight perimeter sidewall.

7. The method of claim 6, wherein the shield is embossed to complement that embossed appearance of the lamp oil cartridge.

8. The method of claim 2, wherein the step of providing heat shrinkable material further comprises the heat shrinkable material being generally transparent.

9. The method of claim 8, wherein the step of heat shrinking includes heat shrinking the heat shrinkable material so that the heat shrinkable material overlaps an entire edge of the lamp oil cartridge between the base and the sidewall to present a generally seamless look around a bottom portion of the lamp oil cartridge.

10. The method of claim 9, wherein the step of heat shrinking includes heat shrinking the heat shrinkable material so that the heat shrinkable material overlaps at least a portion of the neck to present a generally seamless look around an upper portion of the lamp oil cartridge.

11. The method of claim 10, further comprising providing a shield for the lamp oil cartridge, the lamp oil cartridge being generally cylindrical in cross section and having a generally straight perimeter sidewall.

12. The method of claim 11, wherein the shield is embossed to complement that embossed appearance of the lamp oil cartridge.

13. The method of claim 2, further comprising inserting oil into the lamp oil cartridge after the heat shrinking of the heat shrinkable material.

14. The method of claim 2, further comprising inserting oil into the lamp oil cartridge before the heat shrinking of the heat shrinkable material.

15. An oil lamp with simulated embossing, comprising:
a lamp oil cartridge enclosing an oil, the lamp oil cartridge having a base with a perimeter sidewall, the perimeter sidewall extending generally perpendicularly outwardly from the base, then extending through an approximately ninety degree bend to extend radially inwardly, and then bending generally away from the base to form a neck, the neck of the lamp oil cartridge being generally opposite from the base;
a wick extending through the neck and in contact with the oil;
a wrap material positioned about the lamp oil cartridge with at least one raised portion thereon, the wrap material being transparent to blend with the lamp oil cartridge to create an embossed, glass-like appearance for the lamp oil cartridge.

16. The oil lamp of claim 15, wherein the wrap material overlaps an entire edge of the lamp oil cartridge between the base and the sidewall to present a generally seamless look around a bottom portion of the lamp oil cartridge.

17. The oil lamp of claim 16, wherein the wrap material overlaps at least a portion of the neck to present a generally seamless look around an upper portion of the of the lamp oil cartridge.

18. The oil lamp of claim 17, further comprising a shield positioned over the lamp oil cartridge, the shield being generally cylindrical in cross section and having a generally straight perimeter sidewall.

19. The oil lamp of claim 18, wherein the shield is embossed to complement the embossed appearance of the lamp oil cartridge.

20. The oil lamp of claim 15, wherein the wrap material is a water shrink material.

21. The oil lamp of claim 15, wherein the wrap material is a heat shrink material.

22. The oil lamp of claim 15, wherein the wrap material is not a shrink material, the wrap material closely overlapping the lamp oil cartridge.

23. The method of claim 1, wherein the step of providing the shield further comprises the shield being embossed to complement the embossed appearance of the lamp oil cartridge.
